(19) United States
(12) Patent Application Publication
(10) Pub. No.: US 2014/0368144 A1
(43) Pub. Date: Dec. 18, 2014

(54) THERMAL PROTECTION OF A BRUSHLESS MOTOR

(71) Applicant: DYSON TECHNOLOGY LIMITED, Wiltshire (GB)

(72) Inventor: Tuncay CELIK, Swindon (GB)

(21) Appl. No.: 14/304,491

(22) Filed: Jun. 13, 2014

(30) Foreign Application Priority Data
Jun. 13, 2013 (GB) 1310568.9

(51) Int. Cl. H02P 6/00

(52) U.S. Cl. CPC H02P 6/002
USPC 318/400.22

(57) ABSTRACT

A method of controlling a brushless motor. The method includes storing a power lookup table that comprises a control value for each of a plurality of voltages or speeds, measuring the magnitude of a supply voltage or the speed of the motor, and indexing the power lookup table using the measured voltage or speed to select a control value. The method further includes measuring a temperature of the motor and applying a compensation value to the selected control value in the event that the measured temperature exceeds a threshold. A winding of the motor is then excited with the supply voltage and the selected control value is used to define an attribute of excitation. The compensation value, when applied to the selected control value, causes a reduction in the input power of the motor.

### REFERENCE TO RELATED APPLICATION

This application claims priority of United Kingdom Application No. 1310568.9, filed Jun. 13, 2013, the entire contents of which are incorporated herein by reference.

### FIELD OF THE INVENTION

The present invention relates to a method of controlling a brushless motor so as to protect the motor from excessive temperatures.

### BACKGROUND OF THE INVENTION

Excessive temperatures within a brushless motor may damage one or more components. For a motor that comprises a permanent-magnet rotor, excessive temperatures may demagnetise the magnet. In order to protect the motor, the motor may be turned off should the temperature exceed a threshold. Whilst this then protects the motor, it has the obvious disadvantage that the motor is rendered inoperable.

### SUMMARY OF THE INVENTION

The present invention provides a method of controlling a brushless motor, the method comprising storing a power lookup table, the power lookup table comprising a control value for each of a plurality of voltage or speeds, measuring the magnitude of a supply voltage or the speed of the motor, indexing the power lookup table using the measured voltage or speed to select a control value, measuring a temperature of the motor, applying a compensation value to the selected control value in the event that the measured temperature is greater than a predefined threshold, and exciting a winding of the motor with the supply voltage, wherein the selected control value is used to define an attribute of excitation, and the compensation value when applied to the selected control value reduces the input power of the motor.

By reducing the input power of the motor in the event that the temperature exceeds a threshold, power losses are reduced and thus less heat is generated by the motor. As a result, further temperature increases may be averted. Indeed, the reduction in the input power may be such that the temperature of the motor decreases. Should the temperature of the motor subsequently drop below the threshold, no compensation is applied to the control value and thus the motor is once again driven at full input power. The method therefore acts to protect thermally the motor whilst still permitting the motor to operate.

The method may comprise employing a single, fixed compensation value. The compensation value may be set such that, even at temperatures well in excess of the threshold, the input power is reduced by an amount that causes the temperature of the motor to stabilise or decrease. This then has the advantage of reducing the memory requirements of the hardware used to implement the method. A disadvantage, however, is that the compensation value is larger than that necessary to stabilise or reduce the temperature of the motor when the temperature is just above the threshold. As a result, the input power of motor is reduced by an amount far greater than that necessary for thermal protection. Additionally, the input power of the motor may oscillate excessively as the relatively large compensation is applied, the temperature decreases below the threshold, the compensation is removed, and the temperature rises above the threshold. Accordingly, rather than employing a single compensation value, the method may comprise employing a compensation value that is temperature dependent. A larger compensation value is then applied to the selected control value in response to a higher temperature such that the input power of the motor is reduced by a larger amount. The input power is therefore reduced by an amount that is commensurate with the temperature. This then has the advantage that the motor may be protected thermally whilst maximising the input power of the motor.

The method may comprise storing a temperature lookup table that comprises a compensation value for each of a plurality of temperatures, and indexing the temperature lookup table using the measured temperature to select the compensation value. This then has the advantage that a temperature-dependent compensation value may be obtained in a relatively simple manner. In particular, it is not necessary to solve a potentially complex equation. As a result, the hardware used to implement the method may be relatively cheap and simple.

The control value may be used to define the phase or the length of excitation. More particularly, the method may comprise exciting the winding relative to zero-crossings of back EMF or rising inductance in the winding at times defined by a phase period, and exciting the winding for a conduction period. The control value may then define the phase period or the conduction period. Additionally, the compensation value may reduce the length of the phase period or the length of the conduction period.

The method may comprise dividing each half of an electrical cycle of the motor into a conduction period followed by freewheel period, and the control value may define one of a phase and a length of the conduction period.

In spite of the compensation applied to the selected control value, the temperature of the motor may continue to rise. Accordingly, the method may comprise turning off the motor in the event that the measured temperature exceeds a further threshold that is higher than the threshold. This then has the advantage of protecting thermally the motor under conditions for which compensation proves insufficient. Conceivably, it may be possible to apply a compensation value that, even at the further threshold, reduces the input power by an amount sufficient to avert further temperature rise. However, at the further threshold, the drop in input power may be so large that it adversely affects the behaviour of the motor.

The motor may comprise a rotor having a permanent magnet, and the measured temperature may be proportional to the temperature of the magnet. The method may then be used to prevent thermal demagnetisation of the magnet.

The present invention also provides a method of controlling a brushless motor, the method comprising storing a power lookup table, the power lookup table comprising a control value for each of a plurality of voltages or speeds, storing a temperature lookup table, the temperature lookup table comprising a compensation value for each of a plurality of temperatures, measuring the magnitude of a supply voltage or the speed of the motor, measuring a temperature of the motor, indexing the power lookup table using the measured voltage or speed to select a control value, indexing the temperature lookup table using the measured temperature to select a compensation value, applying the selected compensation value to the selected control value to obtain a compensated control value, and exciting a winding of the motor with the supply voltage, wherein the compensated control value is used to define an attribute of excitation.

The present invention further provides a control circuit configured to perform a method as described in any one of the preceding paragraphs, as well as a motor assembly comprising a brushless motor and the control circuit.

The control circuit may comprise a temperature sensor for measuring a temperature of the motor, an inverter for coupling to a winding of the motor, a gate driver module and a controller. The gate driver module then controls switches of the inverter in response to control signals received from the controller. The controller stores the power lookup table, receives an input signal providing a measure of the magnitude of the supply voltage or the speed of the motor, indexes the power lookup table using the measured voltage or speed to select a control value, receives a temperature signal from the temperature sensor, applies a compensation value to the selected control value in the event that the measured temperature of the motor is greater than a predefined threshold, and generates control signals to excite a winding of the motor with the supply voltage. The selected control value is then used to define an attribute of excitation and the compensation value, when applied to the selected control value, reduces the input power of the motor.

### BRIEF DESCRIPTION OF THE DRAWINGS

In order that the present invention may be more readily understood, an embodiment of the invention will now be described, by way of example, with reference to the accompanying drawings, in which:

FIG. 1 is a block diagram of a motor assembly in accordance with the present invention;

FIG. 2 is a schematic diagram of the motor assembly;

FIG. 3 details the allowed states of the inverter in response to control signals issued by the controller of the motor assembly;

FIG. 4 illustrates various waveforms of the motor assembly when operating in acceleration mode;

FIG. 5 illustrates various waveforms of the motor assembly when operating in steady-state mode; and

FIG. 6 details a portion of a temperature lookup table employed by the controller of the motor assembly.

### DETAILED DESCRIPTION OF THE INVENTION

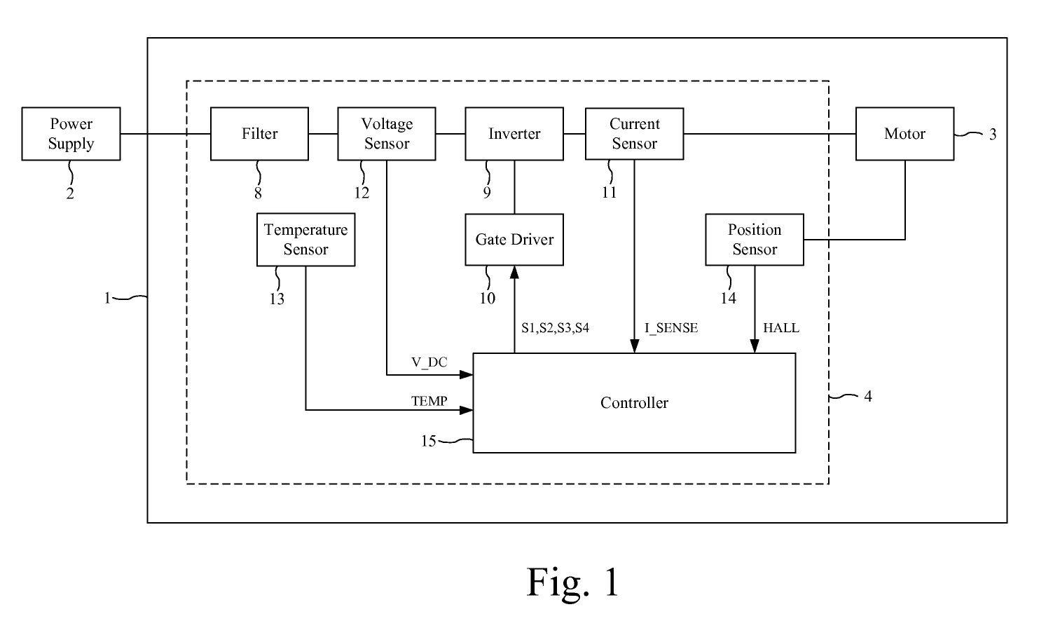

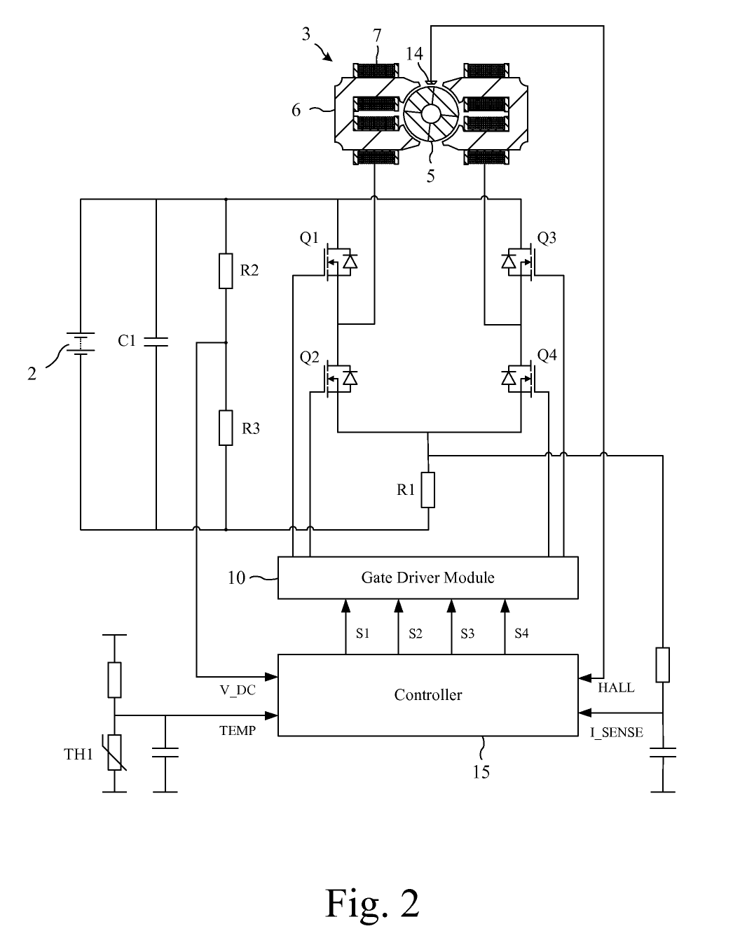

The motor assembly 1 of FIGS. 1 and 2 is powered by a DC power supply 2 and comprises a brushless motor 3 and a control circuit 4.

The motor 3 comprises a rotor 5 having a four-pole permanent magnet, and a stator 6 having two c-shaped cores arranged on opposite sides of the magnet. Conductive wires wound about the stator cores are coupled together to form a single phase winding 7.

The control circuit 4 comprises a filter 8, an inverter 9, a gate driver module 10, a current sensor 11, a voltage sensor 12, a temperature sensor 13, a position sensor 14, and a controller 15.

The filter 8 comprises a link capacitor C1 that smoothes the relatively high-frequency ripple that arises from switching of the inverter 9.

The inverter 9 comprises a full bridge of four power switches Q1-Q4 that couple the phase winding 7 to the voltage rails. Each of the switches Q1-Q4 includes a freewheel diode.

The gate driver module 10 drives the opening and closing of the switches Q1-Q4 in response to control signals received from the controller 15.

The current sensor 11 comprises a shunt resistor R1 located between the inverter and the zero-volt rail. The voltage across the current sensor 11 provides a measure of the current in the phase winding 7 when connected to the power supply 2. The voltage across the current sensor 11 is output to the controller 15 as signal I_PHASE.

The voltage sensor 12 comprises a potential divider R2,R3 located between the DC voltage rail and the zero volt rail. The voltage sensor outputs signal V_DC to the controller 15, which represents a scaled-down measure of the supply voltage provided by the power supply 2.

The temperature sensor 13 comprises a thermistor TH1. The voltage across the thermistor TH1 is output to the controller 15 as signal TEMP.

The position sensor 14 comprises a Hall-effect sensor located in a slot opening of the stator 6. The sensor 14 outputs a digital signal, HALL, that is logically high or low depending on the direction of magnetic flux through the sensor 14. The HALL signal therefore provides a measure of the angular position of the rotor 5.

The controller 15 comprises a microcontroller having a processor, a memory device, and a plurality of peripherals (e.g. ADC, comparators, timers etc.). The memory device stores instructions for execution by the processor, as well as control parameters and lookup tables that are employed by the processor during operation. The controller 15 is responsible for controlling the operation of the motor 3 and generates four control signals S1-S4 for controlling each of the four power switches Q1-Q4. The control signals are output to the gate driver module 10, which in response drives the opening and closing of the switches Q1-Q4.

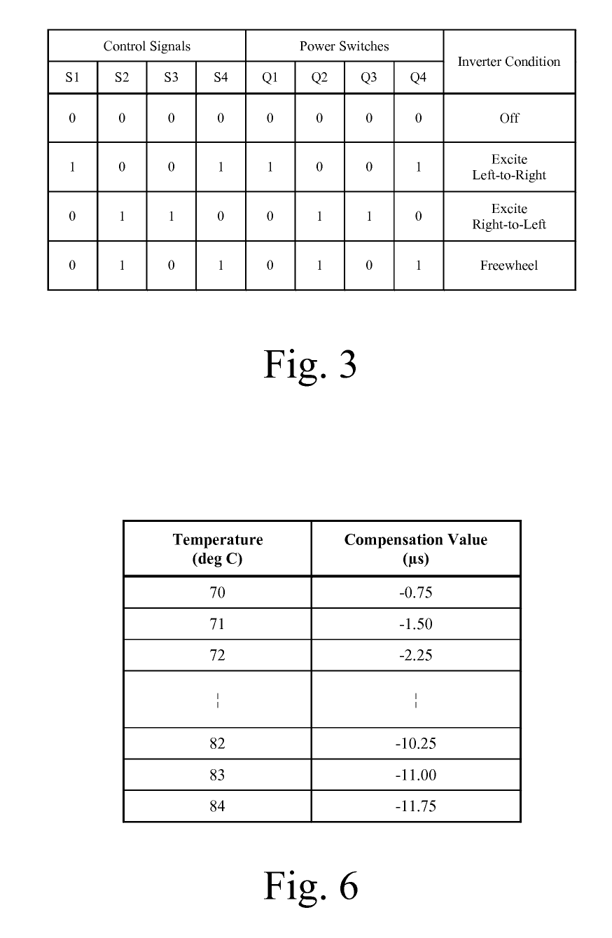

FIG. 3 summarises the allowed states of the switches Q1-Q4 in response to the control signals S1-S4 output by the controller 15. Hereafter, the terms ‘set’ and ‘clear’ will be used to indicate that a signal has been pulled logically high and low respectively. As can be seen from FIG. 3, the controller 15 sets S1 and S4, and clears S2 and S3 in order to excite the phase winding 7 from left to right. Conversely, the controller 15 sets S2 and S3, and clears S1 and S4 in order to excite the phase winding 7 from right to left. The controller 15 clears S1 and S3, and sets S2 and S4 in order to freewheel the phase winding 7. Freewheeling enables current in phase the winding 7 to re-circulate around the low-side loop of the inverter 9. In the present embodiment, the power switches Q1-Q4 are capable of conducting in both directions. Accordingly, the controller 15 closes both low-side switches Q2,Q4 during freewheeling such that current flows through the switches Q2,Q4 rather than the less efficient diodes. Conceivably, the inverter 9 may comprise power switches that conduct in a single direction only. In this instance, the controller 15 would clear S1, S2 and S3, and set S4 so as to freewheel the phase winding 7 from left to right. The controller 15 would then clear S1, S3 and S4, and set S2 in order to freewheel the phase winding 7 from right to left. Current in the low-side loop of the inverter 9 then flows down through the closed low-side switch (e.g. Q4) and up through the diode of the open low-side switch (e.g. Q2).

The controller 15 operates in one of two modes depending on the speed of the rotor 5. At speeds below a predefined threshold, the controller 15 operates in acceleration mode. At speeds at or above the threshold, the controller 15 operates in steady-state mode. The speed of the rotor 5 is determined from the interval, T_HALL, between two successive edges of the HALL signal. This interval will hereafter be referred to as the HALL period.

In each mode the controller 15 commutates the phase winding 7 in response to edges of the HALL signal. Each HALL edge corresponds to a change in the polarity of the rotor 5, and thus a change in the polarity of the back EMF induced in the phase winding 7. More particularly, each HALL edge corresponds to a zero-crossing in the back EMF. Commutation involves reversing the direction of current through the phase winding 7. Consequently, if current is flowing through the phase winding 7 in a direction from left to right, commutation involves exiting the winding from right to left.

Acceleration Mode

When operating in acceleration mode, the controller 15 commutates the phase winding 7 in synchrony with the edges of the HALL signal. Over each electrical half-cycle, the controller 15 sequentially excites and freewheels the phase winding 7. More particularly, the controller 15 excites the phase winding 7, monitors the current signal, I_PHASE, and freewheels the phase winding 7 when the current in the phase winding 7 exceeds a predefined limit Freewheeling then continues for a predefined freewheel period during which time current in the phase winding 7 falls to a level below the current limit At the end of the freewheel period the controller 15 again excites the phase winding 7. This process of exciting and freewheeling the phase winding 7 continues over the full length of the electrical half-cycle. The controller 15 therefore switches from excitation to freewheeling multiple times during each electrical half-cycle.

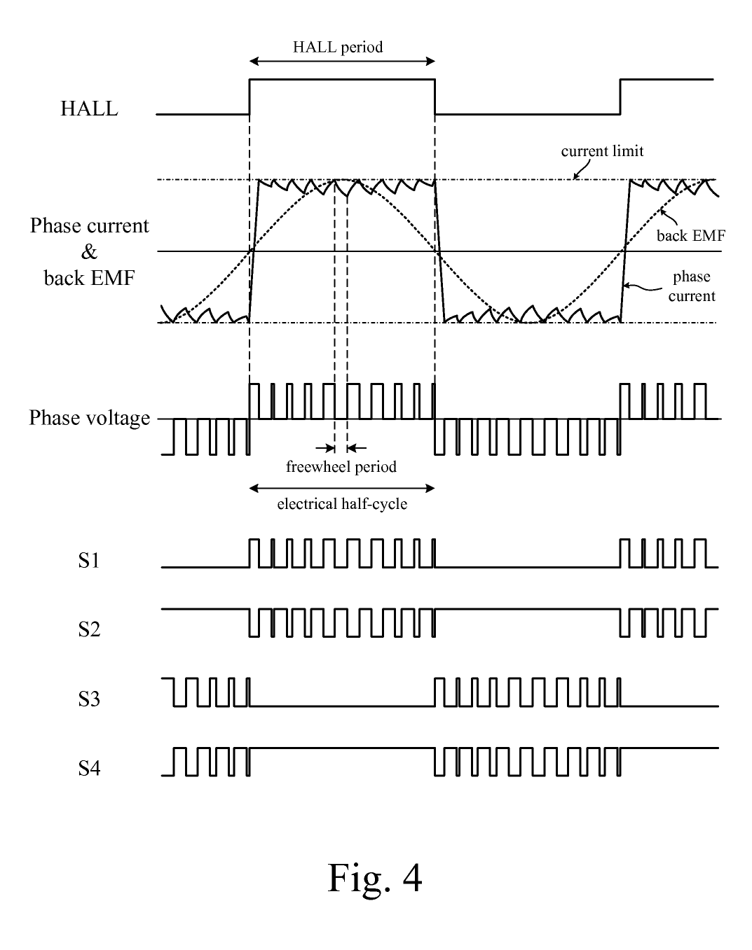

FIG. 4 illustrates the waveforms of the HALL signal, the back EMF, the phase current, the phase voltage, and the control signals over a couple of HALL periods when operating in acceleration mode.

At relatively low speeds, the magnitude of the back EMF induced in the phase winding 7 is relatively small. Current in the phase winding 7 therefore rises relatively quickly during excitation, and falls relatively slowly during freewheeling. Additionally, the length of each HALL period and thus the length of each electrical half-cycle is relatively long. Consequently, the frequency at which the controller 15 switches from excitation to freewheeling is relatively high. However, as the rotor speed increases, the magnitude of the back EMF increases and thus current rises at a slower rate during excitation and falls at a quicker rate during freewheeling. Additionally, the length of each electrical half-cycle decreases. As a result, the frequency of switching decreases.

Steady-State Mode

When operating in steady-state mode, the controller 15 may advance, synchronise or retard commutation relative to each HALL edge. In order to commutate the phase winding 7 relative to a particular HALL edge, the controller 15 acts in response to the preceding HALL edge. In response to the preceding HALL edge, the controller 15 subtracts a phase period, T_PHASE, from the HALL period, T_HALL, in order to obtain a commutation period, T_COM:

T_COM=T_HALL−T_PHASE

The controller 15 then commutates the phase winding 7 at a time, T_COM, after the preceding HALL edge. As a result, the controller 15 commutates the phase winding 7 relative to the subsequent HALL edge by the phase period, T_PHASE. If the phase period is positive, commutation occurs before the HALL edge (advanced commutation). If the phase period is zero, commutation occurs at the HALL edge (synchronous commutation). And if the phase period is negative, commutation occurs after the HALL edge (retarded commutation).

Advanced commutation is employed at higher rotor speeds, whilst retarded commutation is employed at lower rotor speeds. As the speed of the rotor 5 increases, the HALL period decreases and thus the time constant (L/R) associated with the phase inductance becomes increasingly important. Additionally, the back EMF induced in the phase winding 7 increases, which in turn influences the rate at which phase current rises. It therefore becomes increasingly difficult to drive current and thus power into the phase winding 7. By commutating the phase winding 7 in advance of a HALL edge, and thus in advance of a zero-crossing in back EMF, the supply voltage is boosted by the back EMF. As a result, the direction of current through the phase winding 7 is more quickly reversed. Additionally, the phase current is caused to lead the back EMF, which helps to compensate for the slower rate of current rise. Although this then generates a short period of negative torque, this is normally more than compensated by the subsequent gain in positive torque. When operating at lower speeds, it is not necessary to advance commutation in order to drive the required current into the phase winding 7. Moreover, optimum efficiency is typically achieved by retarding commutation.

When operating in steady-state mode, the controller 15 divides each electrical half-cycle into a conduction period followed by a freewheel period. The controller 15 then excites the phase winding 7 during the conduction period and freewheels the phase winding 7 during the freewheel period. When operating within steady-state mode, the phase current is not expected to exceed the current limit during excitation. Consequently, the controller 15 switches from excitation to freewheeling only once during each electrical half-cycle.

The controller 15 excites the phase winding 7 for a conduction period, T_CD. At the end of the conduction period, the controller 15 freewheels the phase winding 7. Freewheeling then continues indefinitely until such time as the controller 15 commutates the phase winding 7. The controller 15 therefore controls excitation of the phase winding 7 using two parameters: the phase period, T_PHASE, and the conduction period, T_CD. The phase period defines the phase of excitation (i.e. the electrical period or angle at which the phase winding 7 is excited relative to zero-crossings in the back EMF) and the conduction period defines the length of excitation (i.e. the electrical period or angle over which the phase winding 7 is excited).

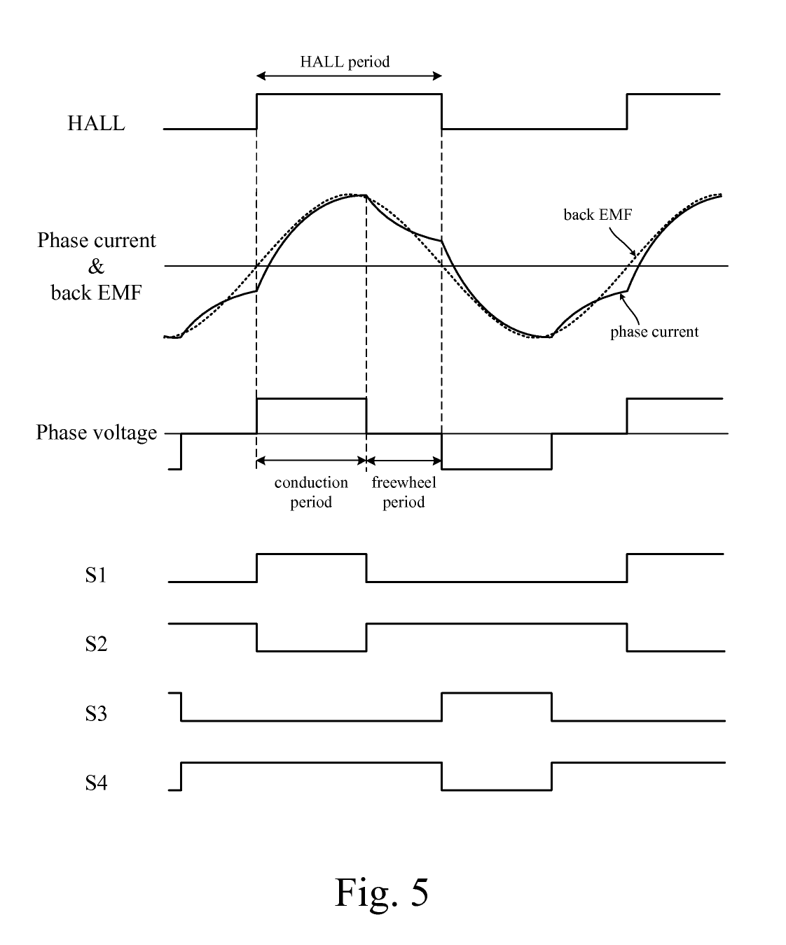

FIG. 5 illustrates the waveforms of the HALL signal, the back EMF, the phase current, the phase voltage, and the control signals over a couple of HALL periods when operating in steady-state mode. In FIG. 5 the phase winding 26 is commutated in synchrony with the HALL edges.

The magnitude of the supply voltage used to excite the phase winding 7 may vary. For example, the power supply 2 may comprise a battery that discharges with use. Alternatively, the power supply 2 may comprise an AC source, rectifier and smoothing capacitor that provide a relatively smooth voltage, but the RMS voltage of the AC source may vary. Changes in the magnitude of the supply voltage will influence the amount of current that is driven into the phase winding 7 during the conduction period. As a result, the power of the motor 3 is sensitive to changes in the supply voltage. In addition to the supply voltage, the power of the motor 3 is sensitive to changes in the speed of the rotor 5. As the speed of the rotor 5 varies (e.g. in response to changes in load), so too does the magnitude of the back EMF. Consequently, the amount of current driven into the phase winding 7 during the conduction period may vary. The controller 15 therefore varies the phase period and the conduction period in response to changes in the magnitude of the supply voltage. The controller 15 also varies the phase period in response to changes in the speed of the rotor 5.

The controller 15 stores a voltage lookup table that comprises a phase period, T_PHASE, and a conduction period, T_CD, for each of a plurality of different supply voltages. The controller 15 also stores a speed lookup table that comprises a speed-compensation value for each of a plurality of different rotor speeds and different supply voltages. The lookup tables store values that achieve a particular input power at each voltage and speed point.

The V_DC signal output by the voltage sensor 12 provides a measure of the supply voltage, whilst the length of the HALL period provides a measure of the rotor speed. The controller 15 indexes the voltage lookup table using the supply voltage to select a phase period and a conduction period. The controller 15 then indexes the speed lookup table using the rotor speed and the supply voltage to select a speed-compensation value. The controller 15 then adds the selected speed-compensation value to the selected phase period so as to obtain a speed-compensated phase period. The commutation period, T_COM, is then obtained by subtracting the speed-compensated phase period from the HALL period, T_HALL.

The speed lookup table stores speed-compensation values that depend not only on the speed of the rotor 5 but also on the magnitude of the supply voltage. The reason for this is that, as the supply voltage decreases, a particular speed-compensation value has a smaller net effect on the input power of the motor 3. By storing speed-compensation values that depend on both the rotor speed and the supply voltage, better control over the input power of the motor 3 may be achieved in response to changes in the rotor speed.

It will be noted that two lookup tables are used to determine the phase period, T_PHASE. The first lookup table (i.e. the voltage lookup table) is indexed using the supply voltage. The second lookup table (i.e. the speed lookup table) is indexed using both the rotor speed and the supply voltage. Since the second lookup table is indexed using both the rotor speed and the supply voltage, one might question the need for two lookup tables. However, the advantage of using two lookup tables is that different voltage resolutions may be used. The input power of the motor 3 is relatively sensitive to the magnitude of the supply voltage. In contrast, the effect that the speed-compensation value has on the input power is less sensitive to the supply voltage. Accordingly, by employing two lookup tables, a finer voltage resolution may be used for the voltage lookup table, and a coarser voltage resolution may be used for the speed lookup table. As a result, relatively good control over the input power of the motor 3 may be achieved through the use of smaller lookup tables, which then reduces the memory requirements of the controller 15.

Thermal Protection

Excessive temperatures within the motor assembly 1 may demagnetise the permanent-magnet rotor 5. The lookup tables therefore store values that ensure that, when the motor assembly 1 is operating under normal conditions, the temperature of the motor assembly 1 does not exceed a threshold. However, the motor assembly 1 may also be required to operate under abnormal conditions. For example, the motor assembly 1 may be used in an environment for which the ambient temperature is relatively high, or the motor assembly 1 may rely on ventilation that subsequently becomes restricted or blocked. The controller 15 therefore employs a method that protects the motor assembly 1 from excessive temperature rises.

When operating in steady-state mode, the controller 15 monitors the temperature of the motor assembly 1 via the TEMP signal. If the temperature exceeds a first threshold, the controller 15 applies a temperature-dependent compensation value to the phase period, T_PHASE. As explained below, the compensation value acts to lower the input power of the motor 3. As a result, power losses within the motor assembly 1 are reduced and thus the heat generated by the motor assembly 1 is reduced. If, however, the temperature exceeds a second, higher threshold, the controller 15 immediately stops the motor 3 by clearing S1-S4.

The controller 15 stores a temperature lookup table that comprises a temperature-compensation value for each of a plurality of different temperatures. The controller 15 then periodically (e.g. during each or every nth HALL period) monitors the TEMP signal. If the temperature of the motor assembly 1 is greater than the first threshold but lower than the second threshold, the controller 15 indexes the temperature lookup table using the measured temperature to select a temperature-compensation value. The controller 15 then adds the selected temperature-compensation value to the speed-compensated phase period. The net result is a phase period that is compensated for both speed and temperature.

FIG. 6 illustrates a portion of the temperature lookup table employed by the controller 15. The first temperature threshold is set at 70 deg C. and the second temperature threshold is set at 85 deg C. As can be seen from FIG. 6, each temperature-compensation value acts to reduce the phase period. As a result, less current and thus power is driven into the phase winding 7 during the conduction period. Since less input power is driven into the motor 3, power losses associated with the motor assembly 1 (e.g. copper losses, iron losses and switch losses) are reduced. Since the power losses are reduced, the heat generated within the motor assembly 1, particularly by the stator 6, is reduced. This in turn causes the temperature of the motor assembly 1 to stabilise or reduce.

The temperature lookup table stores compensation values that increase with temperature. That is to say that a larger compensation value is applied to the phase period in response to a higher temperature, and thus the reduction in the input power of the motor 3 is larger. The input power of the motor 3 is therefore reduced by an amount that is commensurate with the temperature. Consequently, should the temperature of the motor assembly 1 continue to rise after a compensation value has been applied, a larger compensation value is subsequently applied to the phase period. As a result, the input power of the motor 3 is reduced by a larger amount, which should then halt further rises in the temperature or cause the temperature to fall. If, however, the temperature of the motor assembly 1 continues to rise and the second threshold is exceeded, then it would appear that the motor assembly 1 is operating under conditions for which temperature compensation is inadequate. Conceivably, it may be possible to apply a compensation value that, even at the second threshold, reduces the input power by an amount sufficient to avert further temperature rise. However, the drop in input power may be so large as to adversely affect the behaviour of the motor 3. Alternatively, the drop in input power may actually have the opposite effect and cause the temperature of the motor assembly 1 to rise. For example, the motor assembly 1 may be used to drive an impeller and the airflow generated by the impeller may be used to cool the motor assembly 1. As the input power of the motor 3 is reduced, so too is the mass flow rate of the airflow. It is therefore possible that, at the second threshold, the required drop in input power is so large that the resulting drop in the mass flow rate of the airflow causes the temperature of the motor system 1 to rise rather than fall.

In the embodiment described above, the controller 15 varies only the phase period, T_PHASE, in response to changes in the rotor speed and the temperature of the motor assembly 1. Of the two periods (i.e. phase and conduction), the input power of the motor 3 is typically more sensitive to changes in the phase period. Accordingly, better control over the input power of the motor 3 may be achieved by varying the phase period. Nevertheless, in spite of these advantages, the controller 15 could instead vary only the conduction period, T_CD, in response to changes in the rotor speed and the temperature. This may be desirable, for example, if synchronous commutation is employed throughout steady-state mode. Alternatively, the controller 15 may vary both the phase period and the conduction period in response to changes in the rotor speed and/or the temperature of the motor assembly 1. This may be necessary if, for example, the input power of the motor 3 cannot be controlled adequately by varying just the phase period. Or perhaps varying the phase period and the conduction period is desirable in order to improve the efficiency of the motor 3. However, a disadvantage of varying both the phase period and the conduction period is that additional lookup tables are required, thus placing additional demands on the memory of the controller 15.

The controller 15 varies the phase period and the conduction period in response to changes in the supply voltage. This then has the advantage that the efficiency of the motor 3 may be better optimised at each voltage point. Nevertheless, it may be possible to achieve the desired control over the input power of the motor 3 by varying just one of the phase period and the conduction period. Since the input power of the motor 3 is more sensitive to changes in the phase period, better control over the input power may be achieved by varying the phase period. Nevertheless, there may be instances for which it is desirable to vary just the conduction period. For example, the controller 15 might employ synchronous commutation throughout steady-state mode.

The controller 15 may therefore be said to vary the phase period and/or the conduction period in response to changes in the supply voltage and the rotor speed. Whilst the two periods may be varied in response to changes in the supply voltage and the rotor speed, the controller 15 could conceivably vary the periods in response to only one of the supply voltage and the rotor speed. For example, the voltage provided by the power supply 2 may be relatively stable. In the instance, the controller 15 might vary the phase period and/or the conduction period in response to changes in the rotor speed only. Alternatively the motor 3 may be required to operate at constant speed or over a relatively small range of speeds within steady-state mode. In this instance, the controller 15 might vary the phase period and/or the conduction period in response to changes in the supply voltage only. Accordingly, in a more general sense, the controller 15 may be said to vary the phase period and/or the conduction period in response to changes in the supply voltage and/or the rotor speed. Moreover, rather than storing a voltage lookup table or a speed lookup table, the controller 15 may be said to store a power lookup table that comprises different control values for different supply voltages and/or rotor speeds. Each control value then achieves a particular input power at that particular voltage and/or speed point. The controller 15 then indexes the power lookup table using the supply voltage and/or the rotor speed to select a control value from the power lookup table. The control value is then used to define the phase period or the conduction period.

When operating in steady-state mode, the controller 15 divides each electrical half-cycle into a conduction period followed by a freewheel period. The controller 15 then excites the phase winding 7 during the conduction period and freewheels the phase winding 7 during the freewheel period. The phase current is not expected to exceed the current limit during the conduction period and thus the controller 15 switches from excitation to freewheeling only once during each electrical half-cycle. The power lookup table then stores control values that are used to define the phase or the length of the conduction period. However, the controller 15 could conceivably employ an alternative scheme for controlling the excitation of the phase winding 7 when operating in steady-state mode. For example, the controller 15 may employ the same scheme as that employed in acceleration mode. In this instance, the control values stored by the power lookup table may be used to define the current limit or the length of the freewheel period. Accordingly, in a more general sense, the control value may be said to define an attribute of excitation, e.g. phase period, conduction period, current limit or freewheel period. Irrespective of what attribute the control value defines, the temperature compensation value, when applied to the control value, causes the motor 3 to be driven at lower input power.

Rather than storing a lookup table of different temperature compensation values, the controller 15 might instead employ an equation to determine the compensation value to be applied to the selected control value. Whilst this then reduces the memory requirements of the controller 15, the controller 15 is required to perform a calculation that may be relatively complex for the processor, thus requiring a more expensive controller. As a further alternative, the controller 15 might employ a single, fixed compensation value. The compensation value may then be set such that, at temperatures just below the second threshold, the input power is reduced by an amount that causes the temperature of the motor assembly 1 to stabilise or decrease. This then has the advantage of reducing the memory requirements of the controller 15. A disadvantage, however, is that the compensation value is larger than that necessary to stabilise or reduce the temperature of the motor assembly 1 when the temperature is just above the first threshold. As a result, the input power of motor 3 is reduced by an amount far greater than that necessary for thermal protection. Additionally, the input power of the motor 3 may oscillate excessively as the relatively large compensation value is applied, the temperature decreases below the first threshold, the compensation value is removed, and the temperature again rises above the first threshold.

The motor assembly 1 comprises a motor 3 having a permanent-magnet rotor 5. The controller 15 then employs a method that protects the rotor 5 from thermal demagnetisation. However, the method is not limited to motor assemblies having a permanent-magnet motor. For example, excessive temperatures within the motor system may shorten the lifespan of bearings or electrical components (e.g. the power switches Q1-Q4). The method employed by the controller 15 may therefore be used to protect thermally motor assemblies having different types of brushless motor. For a permanent-magnet motor, the phase winding is typically commutated at times relative to zero-crossings in the back EMF induced in the phase winding. The phase period, T_PHASE, therefore corresponds to the interval between commutation and a zero-crossing in the back EMF. For a reluctance motor, on the other hand, the phase winding is typically commutated at times relative to minima in the inductance of the phase winding. The phase period then corresponds to the interval between commutation and a minimum in the inductance.

1. A method of controlling a brushless motor, the method comprising:
storing a power lookup table, the power lookup table comprising a control value for each of a plurality of voltages or speeds;
measuring the magnitude of a supply voltage or the speed of the motor;
indexing the power lookup table using the measured voltage or speed to select a control value;
measuring a temperature of the motor;
applying a compensation value to the selected control value in the event that the measured temperature is greater than a predefined threshold; and
exciting a winding of the motor with the supply voltage,
wherein the selected control value is used to define an attribute of excitation, and the compensation value when applied to the selected control value reduces the input power of the motor.

2. The method of claim 1, wherein the compensation value is temperature dependent, and a larger compensation value is applied to the selected control value in response to a higher temperature such that the reduction in the input power is larger.

3. The method of claim 1, wherein the method comprises storing a temperature lookup table that comprises a compensation value for each of a plurality of temperatures, and indexing the temperature lookup table using the measured temperature to select the compensation value.

4. The method of claim 1, wherein the control value defines the phase or the length of excitation.

5. The method of claim 1, wherein the method comprises exciting the winding relative to zero-crossings of back EMF or rising inductance in the winding at times defined by a phase period, and exciting the winding for a conduction period, and the control value defines the phase period or the conduction period.

6. The method of claim 1, wherein the method comprises dividing each half of an electrical cycle of the motor into a conduction period followed by freewheel period, and the control value defines one of a phase and a length of the conduction period.

7. The method of claim 1, wherein the method comprises turning off the motor in the event that the measured temperature is greater than a predefined further threshold higher than the threshold.

8. The method of claim 1, wherein the motor comprises a rotor having a permanent magnet, and the measured temperature is proportional to the temperature of the magnet.

9. A method of controlling a brushless motor, the method comprising:
storing a power lookup table, the power lookup table comprising a control value for each of a plurality of voltages or speeds;
storing a temperature lookup table, the temperature lookup table comprising a compensation value for each of a plurality of temperatures;
measuring the magnitude of a supply voltage or the speed of the motor;
measuring a temperature of the motor;
indexing the power lookup table using the measured voltage or speed to select a control value;
indexing the temperature lookup table using the measured temperature to select a compensation value;
applying the selected compensation value to the selected control value to obtain a compensated control value; and
exciting a winding of the motor with the supply voltage, wherein the compensated control value is used to define an attribute of excitation.

10. A control circuit for a brushless motor, the control circuit being configured to:
store a power lookup table, the power lookup table comprising a control value for each of a plurality of voltages or speeds;
measure the magnitude of a supply voltage or the speed of the motor;
index the power lookup table using the measured voltage or speed to select a control value;
measure a temperature of the motor;
apply a compensation value to the selected control value in the event that the measured temperature is greater than a predefined threshold; and
excite a winding of the motor with the supply voltage,
wherein the selected control value is used to define an attribute of excitation, and the compensation value when applied to the selected control value reduces the input power of the motor.

11. The control circuit of claim 10, wherein the control circuit is included in a motor assembly for a brushless motor.

12. A control circuit for a brushless motor, the control circuit being configured to:
store a power lookup table, the power lookup table comprising a control value for each of a plurality of voltages or speeds;
store a temperature lookup table, the temperature lookup table comprising a compensation value for each of a plurality of temperatures;
measure the magnitude of a supply voltage or the speed of the motor;
measure a temperature of the motor;
index the power lookup table using the measured voltage or speed to select a control value;
index the temperature lookup table using the measured temperature to select a compensation value;
apply the selected compensation value to the selected control value to obtain a compensated control value; and
exciting a winding of the motor with the supply voltage, wherein the compensated control value is used to define an attribute of excitation.

13. The control circuit of claim 12, wherein the control circuit is included in a motor assembly for a brushless motor.
